(19) United States
(12) Patent Application Publication
(10) Pub. No.: US 2004/0097144 A1
(43) Pub. Date: May 20, 2004

(54) Anti-back-out cable termination devices

(76) Inventor: Richard Vest Campbell, Tallahassee, FL (US)

Correspondence Address: John Wiley Horton, Attorney, Pennington, Moore, Wilkinson, Bell & Dunbar, P.A., P. O. Box 10095, Tallahassee, FL, 32302-2095, US

(21) Appl. No.: 10/703,777

(22) Filed: Nov. 7, 2003

Related U.S. Application Data
(60) Provisional application No. 60/426,083, filed on Nov. 13, 2002.

(51) Int. Cl. H01R 9/22

(52) U.S. Cl. 439/894

(57) ABSTRACT

A variety of different cable termination anchor assemblies, all of which tend to prevent a potted region from backing out of the anchor while allowing the motion needed to properly seat the potted region in the anchor. The anchors incorporate one or more features which lock over the top of the potted region and prevent it from backing out of the anchor.

### CROSS-REFERENCES TO RELATED APPLICATIONS

Pursuant to the provisions of 37 CFR § 1.53(c), this application claims the benefit of an earlier-filed provisional application. The provisional application was assigned Serial No. 60/426,083. It was filed on Nov. 13, 2002.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of rope and cable. More specifically, the invention comprises a cable termination that prevents a potted portion from backing out of an anchor.

2. Description of the Related Art

Devices for mounting a termination on the end of a rope or cable are disclosed in detail in copending U.S. Application Serial No. 60/404,973 to Campbell, which is incorporated herein by reference. The individual components in wire ropes are commonly referred to as “strands,” whereas the individual components in natural or synthetic cables are sometimes referred to as “fibers.” Throughout this disclosure, the term “strands” will be used to refer to both “strands” and “fibers.” In order to attach some sort of load-carrying fixture (a hook, an eye, a threaded stud, etc.) to a cable, one common procedure is to wet the strands proximate the end of the cable with a potting compound to affix them to an anchor. The term “potting” refers to applying a liquid “potting compound” to the cables strands in order to lock them to something else. The potting compound turns from a liquid to a solid after it has been applied.

The term “anchor” refers to the mechanical device which is affixed to the cable. The term “termination” refers to the anchor along with the attachment means and the portion of the cable subject to the attachment means. If, as an example, a short length of cable is glued inside an interior passage through an anchor, then the term “termination” would refer to the anchor, the short length of cable, and the solidified adhesive operating in conjunction to form a load-carrying system.

One common method for potting an anchor having an internal passage is to slip the anchor down the cable, splay the strands on the end of the cable, then pull the anchor over the splayed strands so that they lie tightly within the anchor's internal passage (a sort of mold). The potting compound—in liquid form—is then poured into the open end of the fitting. It then flows in and around the strands, wetting them and locking them to the anchor.

Another method is to place the anchor on the cable and slide it a short distance down the cable's length. The strands on the end of the cable are then “painted” with the liquid potting compound (or dipped into a vat, or otherwise infused with the liquid potting compound). The anchor is then pulled around the wetted strands, roughly molding them into the shape of the internal passage through the fitting. Those skilled in the art will know that a termination can be added to a cable in intermediate positions (i.e., not on the end of the cable). Different wetting techniques may be used, but the principles are the same.

Because cables tend to be flexible, they are customarily only loaded in tension. Thus, terminations applied to cables are generally designed to resist separation primarily in tension. However, when the tension on a terminated cable is suddenly released, the potted portion of the termination may tend to back out of the anchor. This can be a dangerous phenomenon since, when loaded with high forces, the potted portion of the termination may fly free at high velocity. This is especially true when the cable breaks, whereupon the entire potted section may be ejected from the anchor. In other circumstances, the potted section may slowly back out over time.

FIG. 1 shows a prior art approach to solving this problem. Anchor 10 has recess 16 cut into expanding cavity 14. Cable 18 is potted by exposing and splaying the fibers on its end and placing them within expanding cavity 14 in anchor 10. Liquid potting compound is infused throughout the fibers contained within expanding cavity 14 (by whatever method). When the liquid potting compound solidifies, a solid “plug” of strands and solidified potting compound is formed within expanding cavity 14. This “plug” is denoted as potted region 12 in the view. The “molding” action in the potting process forms ring 58. Ring 58 then mechanically interlocks with recess 16.

This solution has proved unsatisfactory for two main reasons. First, the interface of ring 58 with recess 16 tends to put all the tensile load in this one plane—resulting in the shear failure of ring 58. Second, the mechanical interlocking prevents potted terminations from moving slightly up and down within expanding cavity 14. This motion is beneficial to the proper seating of the potted termination. Many prior art anchors omit recess 16 (FIG. 2 shows such an anchor). Thus, they have no mechanical interlock other than the tapering shape of the expanding cavity itself. The potting compound will typically adhere to the wall of expanding cavity 14 when the termination is first made. However, when the cable is first loaded, this relatively weak surface bond tends to break. Potted region 12 then pulls down slightly toward the smaller end of expanding cavity 14, until the compression of the material slows further movement. This process allows the potted region to “seat” itself properly. Thus, the reader will appreciate that once the cable has been loaded at least one time, potted region 12 will generally be able to move within expanding cavity 14.

### BRIEF SUMMARY OF THE PRESENT INVENTION

The present invention comprises several different cable termination assemblies, all of which tend to prevent a potted region from backing out of the anchor containing it, while still allowing the motion preferred to properly seat the termination.

### BRIEF DESCRIPTION OF THE SEVERAL VIEWS OF THE DRAWINGS

FIG. 1 is an isometric section view, showing a prior art cable termination.

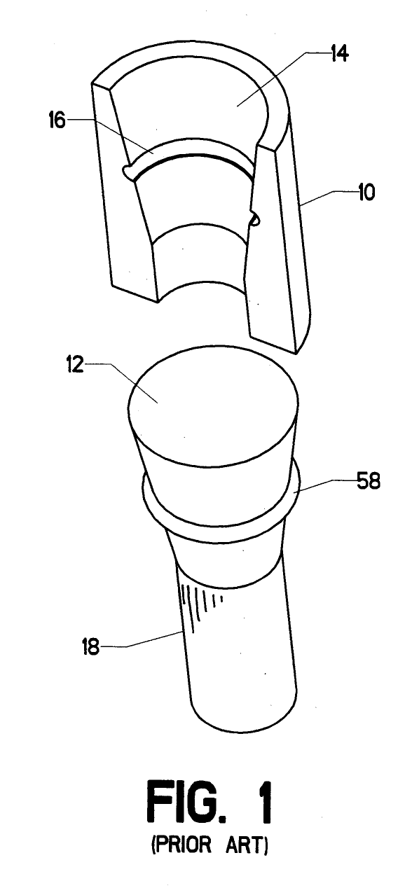

FIG. 2 is an isometric section view, showing a prior art anchor.

FIG. 3 is an isometric section view, showing a modified anchor.

FIG. 4 is an isometric section view, showing a modified anchor.

FIG. 5 is an isometric section view, showing a modified anchor.

FIG. 6 is an isometric section view, showing a modified anchor.

FIG. 7 is an isometric section view, showing a modified anchor.

FIG. 8 is an isometric section view, showing a modified anchor.

FIG. 9 is an isometric section view, showing a modified anchor.

FIG. 10 is an isometric section view, showing a modified anchor.

FIG. 11 is an isometric section view, showing a modified anchor.

FIG. 12 is an isometric section view, showing a modified anchor.

FIG. 13 is an isometric section view, showing a modified anchor.

FIG. 14 is an isometric view, showing a modified anchor.

### REFERENCE NUMERALS IN THE DRAWINGS

10 anchor 12 potted region

14 cavity 16 recess

18 cable 20 straight portion

22 expanding portion 24 contracting portion

26 square overhang 28 reduced diameter

30 locking tab 32 ring recess

34 locking ring 36 transverse hole

38 locking key 40 locking cap

42 straight portion 44 hatchet chop

46 elastic finger 48 fillet

50 channel 52 clip

54 cover 56 snap opening

58 ring

### DESCRIPTION OF THE INVENTION

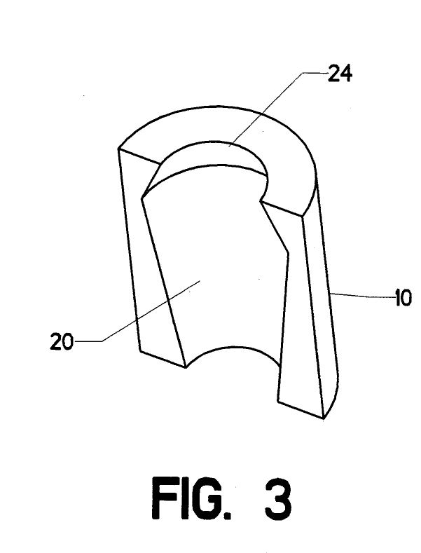

FIG. 3 shows a modified anchor 10. The upper portion of the internal cavity forms reverse expanding portion 24. When potting compound hardens within the internal cavity, contracting portion 24 will prevent the potted portion of the termination from flying out the top of anchor 10 in the event of a loss of tension. It also prevents the potted termination from gradually working its way out the top under cyclic tension and relaxation. However, it still allows some up and down movement (with respect to the orientation shown in the view) in order to allow the aforementioned desirable “seating” of the potted portion.

The reader may naturally wonder how much “up and down” movement is possible with the geometry shown in FIG. 3. The reader should be aware that the angles of taper shown for the internal walls within the anchor may be different than the angles shown in most of the drawing figures. As an example, FIG. 3 shows expanding portion with a 10 degree angle on the wall, and contracting portion with a 20 degree angle on the wall. In reality, the angles used might be more like 3 degrees and 5 degrees. Graphical depictions of these small angles are difficult to discern. Versions using the larger angles have therefore been illustrated. The actual angle employed is not critical to the present invention.

A comparison of designs using large and small angles is provided subsequently. However, those skilled in the art will realize that small up and down movement of the potted region is possible with practically any angle. The up and down movement is limited by the compression of the potted region within the tapering internal walls of the anchor.

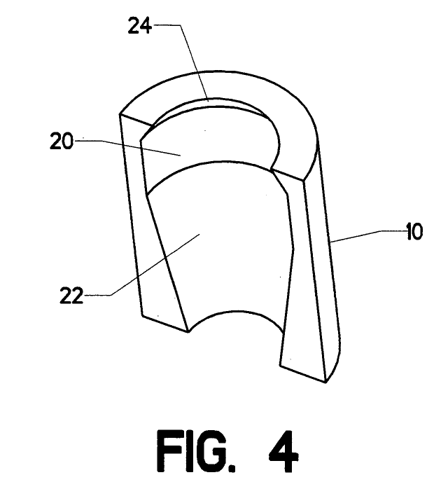

FIG. 4 shows another concept designed to trap the potted region. It incorporates straight portion 20. The incorporation of this straight side wall can reduce stress concentrations. The reader will recall that the cavity within the anchor acts as a mold for the liquid potting compound and strands it contains. Looking back as FIG. 3, those skilled in the art will realize that the “mold” in this anchor will form a potted region having a sharp corner with little reinforcement above this corner. When the cable is then loaded, stress will be concentrated on this sharp corner.

Looking now at FIG. 4, the reader will observe that a non-sharp corner will be formed at the intersection between expanding portion 22 and straight portion 20. This non-sharp corner is reinforced by the existence of a purely cylindrical section lying above it (formed by straight portion 20). Thus, the version shown in FIG. 4 has some advantages over the version shown in FIG. 3.

The inclusion of a straight portion can serve other purposes as well. It can be used to simply lengthen the anchor, which may be needed when external threads or other features are to be added to the anchor's external surface. More length may also be needed when a secondary operation (such as swaging) is to be performed on the portion of the anchor above the potted region.

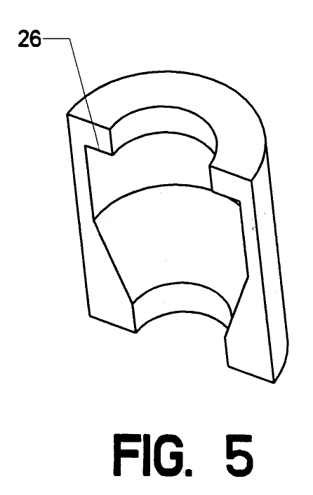

The version shown in FIG. 4 also incorporates a contracting portion 24 positioned to retain the potted region within the anchor. The overhanging portion of wall need not be a linear taper. It can assume a variety of shapes. FIG. 5 shows square overhang 26. Curved overhangs, stepped overhang, or parabolic overhangs may also be suitable. Such overhangs could be applied to the anchor shown in FIG. 3 as well.

The versions shown in FIGS. 3 through 5 contemplate the casting of the potted termination within the internal cavity of the anchor. These versions generally contemplate the application of the anchor as follows:

1. The strands on an end of a cable are exposed and prepared for potting;

2. The anchor is slipped over the exposed strands and down the cable a short length; and

3. The strands are splayed and wetted with potting compound before pulling the anchor back up over the strands to hold them in place while the potting compound solidifies.

Alternatively, the anchor may be applied as follows:

1. The strands on an end of a cable are exposed and prepared for potting;

2. The anchor is slipped over the exposed strands and down the cable a short length;

3. The strands are splayed;

4. The anchor is pulled back up over the strands; and

5. Liquid potting compound is poured into the open end of the anchor to wet the strands in place.

In the event that the cable is cut to length, another alternative may be employed as follows:

1. The strands on a first end of a cable are exposed and prepared for potting;

2. The strands are splayed;

3. The strands are wetted with liquid potting compound;

4. The anchor is slipped over the second end of the cable and pulled along the cable until it slips over the wetted strands.

In this last alternative, the anchor can be applied to the cable at any time.

All these approaches require that the upper hole (with “upper” being understood in the context of the orientation shown in the views) be large enough to pass over the cable. These operations are common, but they may not always be the preferred method of creating the termination. If other methods are used, other hardware may be needed.

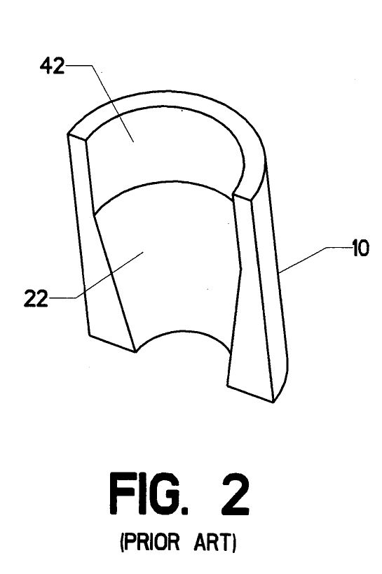

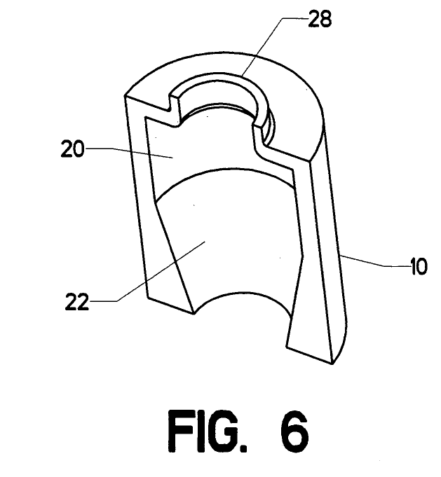

FIG. 6 shows an alternate design that avoids the requirement of having an upper hole large enough to slip over the cable. It allows conventional potting, followed by a secondary swaging operation. Anchor 10 shown in FIG. 6 starts as the same version depicted in FIG. 2. Once the potting compound has hardened, however, a swaging or other re-forming operation is used to create reduced diameter 28 over the top of the potted termination. The swaging actually deforms the anchor material over the top of the potted region to create the geometry shown in FIG. 6.

It is also possible to use a secondary operation—such as swaging—while the potting compound is still in the liquid state. If the top of the anchor is swaged while the potting compound has not yet hardened, the potting compound will tend to fully fill the swaged-down portion of the anchor.

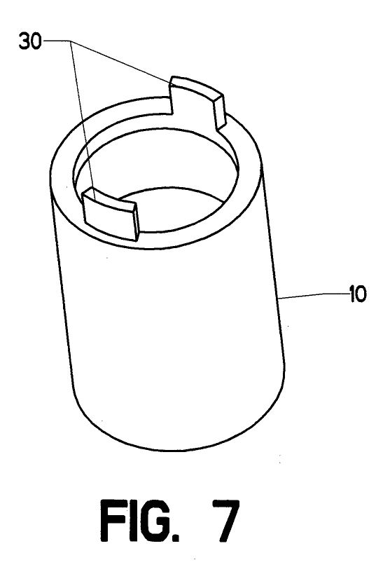

FIG. 7 depicts another approach, in which locking tabs 30 are bent over the top of the potted termination once it hardens. Any mechanical secondary operation which deflects a portion of the anchor over the top of the potted region would work. Other examples include roll crimping (such as used on the mouth of shotgun shell casings) and fold crimping (such as used on 0.22 caliber blank rifle cartridges).

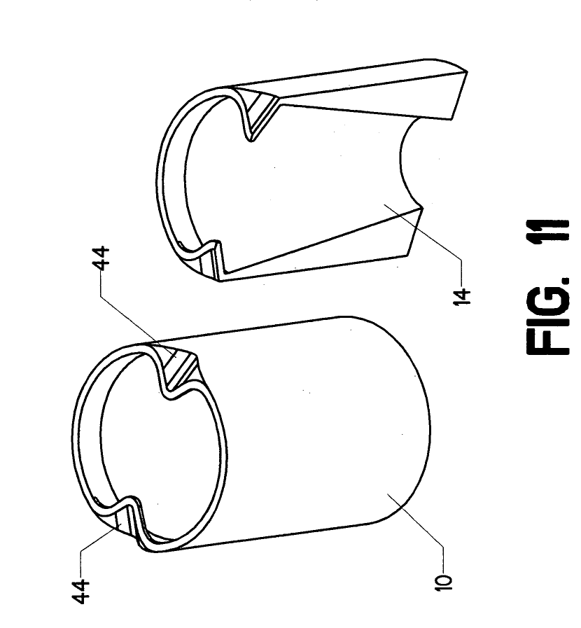

Another example of a mechanical secondary operation is shown in FIG. 11. The version of anchor 10 has the same internal expanding cavity 14. The upper region features relatively thin walls. Once the potted region has solidified, one or more hatchet chops 44 are added to deform the upper wall in and over the top of the potted region. The hatchet chops can be applied using an automatic pressing die or even hand tools.

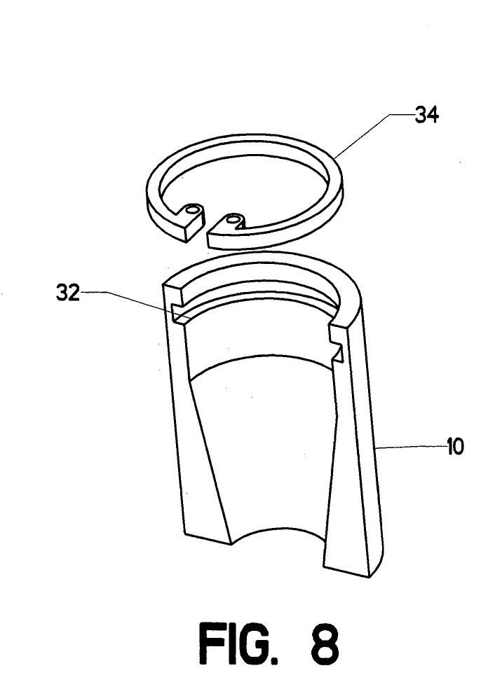

A supplemental mechanical fastening can also be used to prevent the potted portion from backing out of the anchor. FIG. 8 shows an anchor 10 with ring recess 32 cut into its internal cavity. Potting compound is added in order to fill the internal cavity to a level just below ring recess 32. Once the potting compound hardens, ring pliers are used to set locking ring 34 in ring recess 32. The locking ring can be of many types (split washer, “E-ring”, etc.).

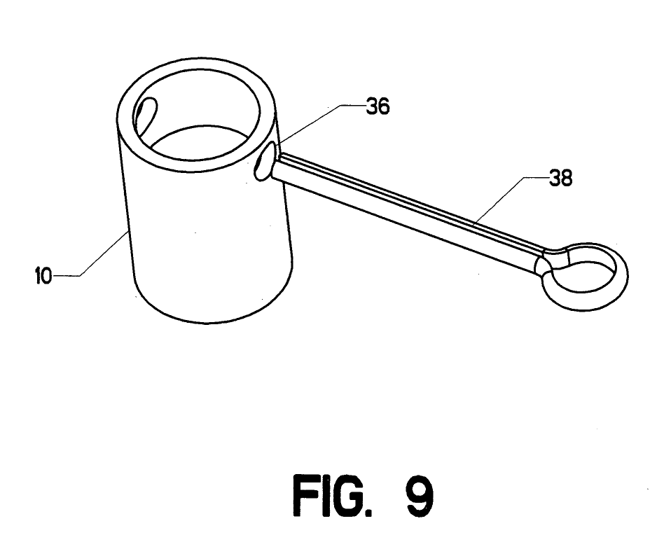

FIG. 9 shows the use of locking key 38 through transverse hole 36 (located just over the top of the potted region) to lock the assembly together. A simple type of key is used. A press fitted dowel or a roll pin could also be used. All of these items are intended to be encompassed by the term “locking key.”

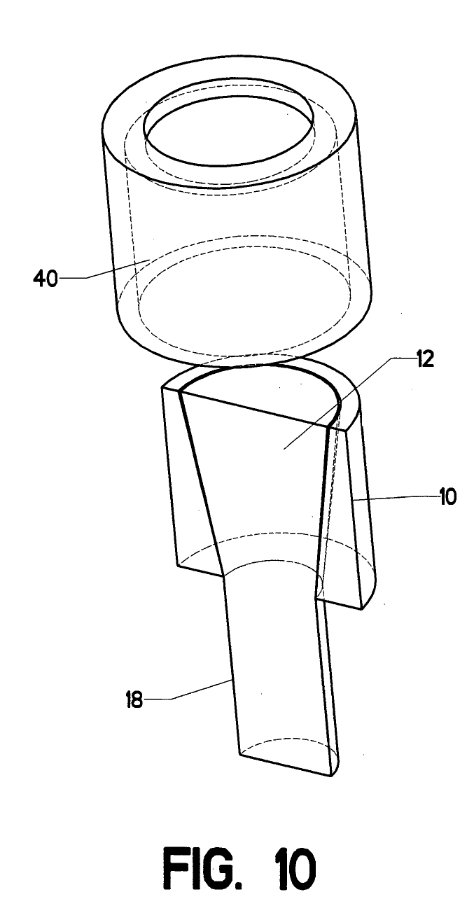

In FIG. 10, a separate locking cap 40 is secured to anchor 10 in order to prevent the potted termination backing out. The securing can be accomplished via the use of an adhesive bond, a threaded engagement, a press fit, or other suitable means.

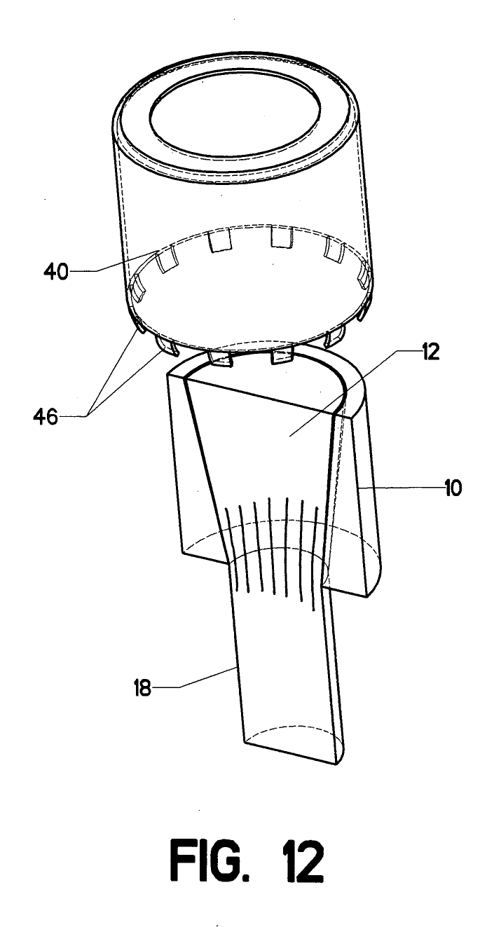

FIG. 12 shows another version of locking cap 40. This version includes a radially spaced set of elastic fingers 46 descending from its lower edge. These can be deformed in order to allow locking cap 40 to slide over anchor 10. Once in place, these elastic fingers snap over the bottom of anchor 10, thereby securing locking cap 40 in place. The fingers can also be made of a malleable (rather than elastic) material, so that they can be bent over the bottom of anchor 10 in order to secure locking cap 40 in place.

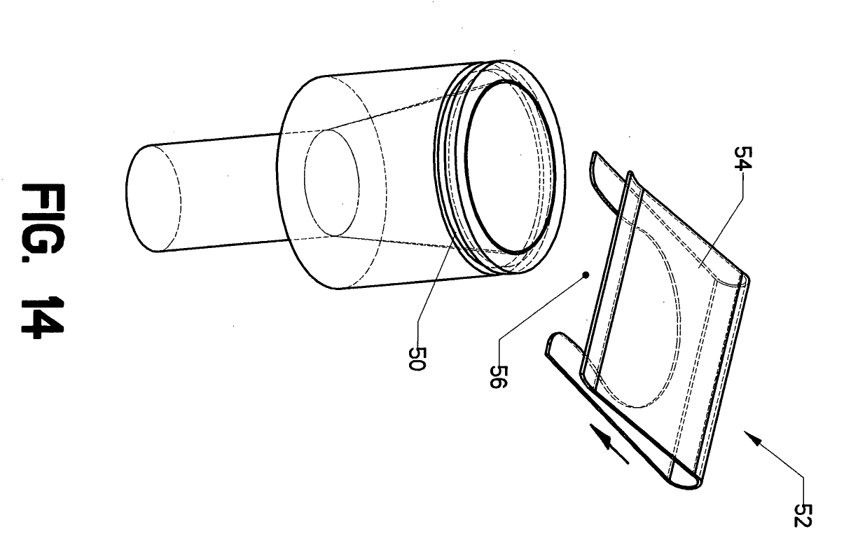

FIG. 14 shows a variation of the theme developed in FIG. 9. Instead of a transverse hole, this version of anchor 10 features an channel 50 cut into its exterior surface. Clip 52 is designed to engage this channel and snap into place. Snap opening 56 slips into and frictionally engages channel 50. Cover 54 then covers the open top of the anchor, thereby securing the potted region.

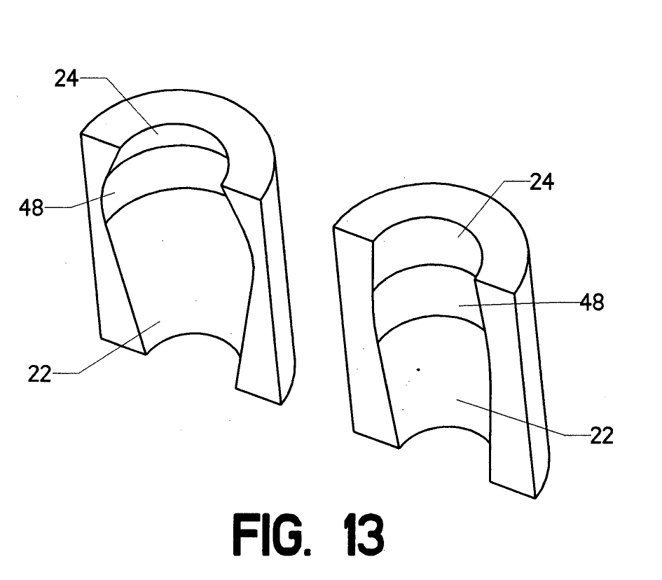

As mentioned previously, the angles of taper shown in the drawing views are generally greater than is actually needed in use. FIG. 13 shows a comparison. The version of anchor 10 shown on the left has an expanding portion 22 and a contracting portion 24 which employ large taper angles. The version shown on the right has an expanding portion 22 and a contracting portion 24 which employ small taper angles. The present invention is not dependent on the actual angle used. It encompasses angles which are larger than the largest angles shown in the views, and angles which are smaller than the smallest angles shown in the views.

The reader will note that the expanding and contracting portions have generally been illustrated with a linear taper. The invention is, of course, not limited to the use of linear tapers. Curved tapers can also be used.

The reader will also note that a fillet 48 is used to join the expanding and contracting portions shown in FIG. 13. Such a fillet may be helpful for reducing stress concentrations and may also be helpful in manufacturing the anchors. Such a fillet can be used to join any of the wall sections shown in any of the anchors disclosed herein.

Finally, the reader will note that all the terminations have been illustrated in a vertical orientation with the cable extending downward. The orientation was consistently used for purposes of visual clarity and obviously has no importance to the invention disclosed. The terms “up”, “down”, “top”, “bottom”, and the like—as they are used in this specification—are to be understood only in the context of the orientation shown in the views, and not as any limitation on the invention.

Although the preceding description contains significant detail, it should not be construed as limiting the scope of the invention but rather as providing illustrations of the preferred embodiments of the invention.

Having described my invention, I claim:

1. A cable termination system for securing an anchor to strands on an end of a cable, comprising:
a. said anchor, having a first end and a second end;
b. a cavity within said anchor, having a first end and a second end;
c. wherein said first end of said cavity connects to a first hole in said first end of said anchor;
d. wherein said second end of said cavity connects to a second hole in said second end of said anchor;
e. wherein said cavity includes an expanding portion proximate said first hole, in which said cavity expands proceeding in the direction away from said first hole;
f. wherein said cavity features a contracting portion proximate said second hole, in which said cavity contracts proceeding in the direction away from said expanding portion; and
g. wherein said first and second holes are at least as large as the diameter of said cable.

2. A cable termination system as recited in claim 1, wherein said cavity further comprises a straight portion lying between said expanding portion and said contracting portion.

3. A cable termination system as recited in claim 1, wherein said expanding portion and said contracting portion are joined by a fillet.

4. A cable termination system as recited in claim 2, wherein said expanding portion and said straight portion are joined by a fillet.

5. A cable termination system as recited in claim 4, wherein said straight portion and said contracting portion are joined by a fillet.

6. A cable termination system for securing an anchor to strands on an end of a cable, comprising:
a. said anchor, having a first end and a second end;
b. a cavity within said anchor, having a first end and a second end;
c. wherein said first end of said cavity connects to a first hole in said first end of said anchor;
d. wherein said second end of said cavity connects to a second hole in said second end of said anchor;
e. wherein said cavity includes an expanding portion proximate said first hole, in which said cavity expands proceeding in the direction away from said first hole;
f wherein said first and second holes are at least as large as the diameter of said cable; and
g. wherein said second hole is smaller than the largest portion of said cavity.

7. A cable termination as recited in claim 6, wherein said cavity further comprises a straight portion lying between said expanding portion and said second hole.

8. A cable termination as recited in claim 7, wherein said expanding portion and said straight portion are joined by a fillet.

9. A cable termination system for securing an anchor to strands on an end of a cable, comprising:
a. said anchor, having a first end and a second end;
b. a cavity within said anchor, having a first end and a second end;
c. wherein said first end of said cavity connects to a first hole in said first end of said anchor;
d. wherein said second end of said cavity connects to a second hole in said second end of said anchor;
e. wherein said cavity includes an expanding portion proximate said first hole, in which said cavity expands proceeding in the direction away from said first hole;
f. wherein said first and second holes are at least as large as the diameter of said cable; and
g. at least one pliable locking tab located on said end of said anchor proximate said second hole, so that said pliable locking tab can be bent over said second hole.

10. A cable termination system as recited in claim 9, wherein said cavity further comprises a straight portion lying between said expanding portion and said second hole.

11. A cable termination system as recited in claim 10, wherein said expanding portion and said straight portions are joined by a fillet.

12. A cable termination system for securing an anchor to strands on an end of a cable, comprising:
a. said anchor, having a first end and a second end;
b. a cavity within said anchor, having a first end and a second end;
c. wherein said first end of said cavity connects to a first hole in said first end of said anchor;
d. wherein said second end of said cavity connects to a second hole in said second end of said anchor;
e. wherein said cavity includes an expanding portion proximate said first hole, in which said cavity expands proceeding in the direction away from said first hole;
f. wherein said first and second holes are at least as large as the diameter of said cable;
g. wherein said cavity includes a ring recess proximate said second hole; and
h. an elastic locking ring, capable of snapping into said ring recess.

13. A cable termination system as recited in claim 12, wherein said cavity further comprises a straight portion lying between said expanding portion and said second hole.

14. A cable termination system as recited in claim 13, wherein said expanding portion and said straight portions are joined by a fillet.

15. A cable termination system for securing an anchor to strands on an end of a cable, comprising:
a. said anchor, having a first end and a second end;
b. a cavity within said anchor, having a first end and a second end;
c. wherein said first end of said cavity connects to a first hole in said first end of said anchor;
d. wherein said second end of said cavity connects to a second hole in said second end of said anchor;
e. wherein said cavity includes an expanding portion proximate said first hole, in which said cavity expands proceeding in the direction away from said first hole;
f. wherein said first and second holes are at least as large as the diameter of said cable;
g. a transverse hole through said anchor and said cavity proximate said second end of said anchor; and
h. a locking key sized to fit within said transverse hole.

16. A cable termination system as recited in claim 15, wherein said cavity further comprises a straight portion lying between said expanding portion and said second hole.

17. A cable termination system as recited in claim 16, wherein said expanding portion and said straight portions are joined by a fillet.

18. A cable termination system for securing an anchor to strands on an end of a cable, comprising:
a. said anchor, having a first end and a second end;
b. a cavity within said anchor, having a first end and a second end;
c. wherein said first end of said cavity connects to a first hole in said first end of said anchor;
d. wherein said second end of said cavity connects to a second hole in said second end of said anchor;
e. wherein said cavity includes an expanding portion proximate said first hole, in which said cavity expands proceeding in the direction away from said first hole;
f. wherein said first and second holes are at least as large as the diameter of said cable;
g. a locking cap attached over said anchor, including
i. a first end;
ii. a second end;
iii. wherein said first end opens into a hollow interior sized to slidably fit over said anchor;
iv. a hole in said second end opening into said hollow interior; wherein said hole in said locking cap is smaller than said second hole in said anchor; and
h. attachment means for attaching said locking cap over said anchor.

19. A cable termination system as recited in claim 18, wherein said attachment means comprises at least two elastic fingers extending inward from said end of said locking cap so that when said locking cap is pressed over said anchor, said at least two elastic fingers snap over said first end of said anchor.

20. A cable termination system as recited in claim 19, wherein said attachment means comprises at least two pliable fingers extending inward from said end of said locking cap so that when said locking cap is pressed over said anchor, said at least two fingers can be bent over said first end of said anchor.

21. A cable termination system for securing an anchor to strands on an end of a cable, comprising:
a. said anchor, having a first end and a second end;
b. a cavity within said anchor, having a first end and a second end;
c. wherein said first end of said cavity connects to a first hole in said first end of said anchor;
d. wherein said second end of said cavity connects to a second hole in said second end of said anchor;
e. wherein said cavity includes an expanding portion proximate said first hole, in which said cavity expands proceeding in the direction away from said first hole;
g. wherein said first and second holes are at least as large as the diameter of said cable;
h. wherein said anchor includes an exterior channel proximate said second hole; and
g. a pliable clip, having a portion shaped to snap into said exterior channel and a portion positioned to cover said second hole in said anchor.

22. A method of securing an anchor to strands on an end of a cable using a potting compound, comprising:
a. providing an anchor, including:
i. a first end;
ii. a second end;
iii. a cavity within said anchor, having a first end and a second end;
iv. wherein said first end of said cavity connects to a first hole in said first end of said anchor;
v. wherein said second end of said cavity connects to an opening in said second end of said anchor;
vi. wherein said cavity includes an expanding portion proximate said first hole, in which said cavity expands proceeding in the direction away from said first hole;
b. placing said anchor on said cable so that said first end of said anchor faces away from said end of said cable, and said second end of said anchor faces toward said end of said cable, while being distal to said end of said cable;
c. exposing a length of strands of said cable proximate said end of said cable;
d. infusing said length of strands with said liquid potting compound;
e. moving said anchor along said cable toward said end of said cable until said anchor is proximate said end of said cable;
f. allowing said liquid potting compound to harden into a solid; and
g. after said liquid potting compound has hardened into a solid, reducing the size of said opening in said second end of said anchor in order to trap said solidified potting compound within said expanding passage.

23. A method as recited in claim 22, wherein said step of reducing the size of said opening in said second end of said anchor is accomplished by swaging said second end of said anchor.

24. A method as recited in claim 22, wherein said step of reducing the size of said opening in said second end of said anchor is accomplished by crimping said second end of said anchor.

25. A method as recited in claim 22, wherein said step of reducing the size of said opening in said second end of said anchor is accomplished by hatchet chopping said second end of said anchor.

26. A method of securing an anchor to strands on an end of a cable using a potting compound, comprising:
a. providing an anchor, including:
i. a first end;
ii. a second end;
iii. a cavity within said anchor, having a first end and a second end;
iv. wherein said first end of said cavity connects to a first hole in said first end of said anchor;
v. wherein said second end of said cavity connects to an opening in said second end of said anchor;
vi. wherein said cavity includes an expanding portion proximate said first hole, in which said cavity expands proceeding in the direction away from said first hole;
b. placing said anchor on said cable so that said first end of said anchor faces away from said end of said cable, and said second end of said anchor faces toward said end of said cable, while being distal to said end of said cable;
c. exposing a length of strands of said cable proximate said end of said cable;
d. infusing said length of strands with said liquid potting compound;
e. moving said anchor along said cable toward said end of said cable until said anchor is proximate said end of said cable;
f. while said liquid potting compound is still in a liquid state, reducing the size of said opening in said second end of said anchor; and
g. allowing said liquid potting compound to harden into a solid so that said solidified potting compound is trapped within said expanding passage.

27. A method as recited in claim 26, wherein said step of reducing the size of said opening in said second end of said anchor is accomplished by swaging said second end of said anchor.

28. A method as recited in claim 26, wherein said step of reducing the size of said opening in said second end of said anchor is accomplished by crimping said second end of said anchor.

29. A method as recited in claim 26, wherein said step of reducing the size of said opening in said second end of said anchor is accomplished by hatchet chopping said second end of said anchor.

30. An article of manufacture, prepared by a process as recited in claim 22.

31. An article of manufacture, prepared by a process as recited in claim 23.

32. An article of manufacture, prepared by a process as recited in claim 24.

33. An article of manufacture, prepared by a process as recited in claim 25.

34. An article of manufacture, prepared by a process as recited in claim 26.

35. An article of manufacture, prepared by a process as recited in claim 27.

36. An article of manufacture, prepared by a process as recited in claim 28.

37. An article of manufacture, prepared by a process as recited in claim 29.
